(19) United States
(12) Patent Application Publication
(10) Pub. No.: US 2016/0001199 A1
(43) Pub. Date: Jan. 7, 2016

(54) Chemical Reactor Device

(71) Applicant: PHARMAFLUIDICS NV, Gent (Zwijnaarde) (BE)

(72) Inventors: Wim DE MALSCHE, Berchem (BE); Gert DESMET, Elewijt (BE); Jeff OP DE BEECK, Antwerpen (BE); Paul JACOBS, Lokeren (BE)

(73) Assignee: PHARMAFLUIDICS NV, Gent (Zwijnaarde) (BE)

(21) Appl. No.: 14/765,629

(22) PCT Filed: Feb. 5, 2014
(86) PCT No.: PCT/IB2014/058808

§ 371 Date: Aug. 4, 2015

(30) Foreign Application Priority Data
Feb. 5, 2013 (BE) 2013/0078

(51) Int. Cl. B01D 15/22

(52) U.S. Cl. CPC B01D 15/22

(57) ABSTRACT

A chemical reactor is described comprising a substrate with a fluid channel and a set of organized pillar structures positioned in the channel. The individual pillar structures have a length in the longitudinal direction of the channel and a width in the width direction of the channel whereby their width-to-length aspect ratio is at least 7.

### FIELD OF THE INVENTION

This invention is generally related to chemical reactors. More specifically, the present invention relates to chemical reactors based on a system with elongated pillar structures with a high width-to-length aspect ratio, such as, for example, a liquid chromatography system.

### BACKGROUND OF THE INVENTION

Chemical reactor devices that make use of liquid propagation have a large number of applications, including the production of chemical components, synthesis of nanoparticles, separation and/or extraction of components, etc. Chromatography is a specific example of an accurate way to analyze a separation technique for the separation of mixtures, for instance. There is a variety of forms of chromatography such as gas chromatography, gel chromatography, thin layer chromatography, adsorption chromatography, affinity chromatography, liquid chromatography, etc. Liquid chromatography is typically used in pharmacy and chemistry, both for analytical applications, as well as for production applications. In liquid chromatography use is made of the difference in affinity of different substances with a mobile phase and a stationary phase. Because each substance has its own “adhesive force” to the stationary phase they are transported faster or slower along with the mobile phase and this allows certain substances to be separated. It is in principle applicable to any compound, it has the advantage that no evaporation of the material is necessary and it has the advantage that variations in temperature only have a negligible effect.

An efficient form of liquid chromatography, high-pressure liquid chromatography (also known as high-performance liquid chromatography) or HPLC, where high pressure is used in the separation process. A specific example of a technique to perform HPLC is based on chromatography columns on the basis of pillars. Since their introduction in liquid chromatography, chromatography columns based on pillars proved a worthy alternative for systems based on packed bed structures and monolithic systems. Because of the possibility of applying pillars with a high degree of uniformity and to arrange them perfectly, the dispersion originating from differences in flow paths or “eddy dispersion” can be almost completely avoided. This principle is more generally applicable in chemical reactors which are based on liquid plug flow propagation.

A known problem in liquid chromatography is the occurrence of edge effects. Edge effects originate from the difference in flow rate at the wall of the column and in the middle of the column. The latter can be understood as follows, whereby reference is made to FIG. 1. FIG. 1 shows a portion of a chromatography column. When liquid moves in a chromatography column with pillars, the flow rate is then mutually influenced by channels between pillars by the flow behavior around each of these pillars. Because of the symmetry in pillar structures typically present in a passage, this results in a specific flow behavior. At the edge of the column, on the other hand, the flow behavior in a passage is not influenced symmetrically. At one side of the passage a pillar will typically influence the flow behavior, while at the other side of the passage the wall will influence the flow behavior. It is known that, unless this is corrected, this results in edge effects in the current chromatography columns resulting in a disturbed functioning of the chromatography column to occur.

The problem of edge effects is set out in Vervoort et al., Anal. Chem. (2004) 76 pp 4501-4507. This indicates that small structural variations of the column structures at the wall at a magnitude of only 5% in diameter of the particles can cause a fourfold increase of the band broadening (expressed as plate height) for the result, which results in a dramatic loss in performance.

One way to compensate for this is to adjust the wall of the column. Another—often deployed—way to compensate for this is to adjust the width of the passage at the edge of the column, in relation to the width between pillars in the column, away from the edge. A typical ratio then being implemented is

B=1.25×W

whereby W is the width of the passage at the edge of the column (as shown in FIG. 1) and B is the width of the passage between pillars in the column, away from the edge. This implies not only that it there must be a different design be at the edge of the column, but also that the width of the passage at the edge of the column determines the smallest dimension for the passage and consequently that the width of the passages between the pillars mutually because of this is limited downwards—partly because of a limitation on the minimum distance to be obtained between the wall of the channel and the first pillar through limitations in the production process.

As one often strives for an as small as possible interpillar distance B with the manufacturing method available, this lower limit imposed by wall conditions is not an optimal situation.

### SUMMARY OF THE INVENTION

It is an objective of the embodiments of the present invention to provide for good chemical reactor system and methods on the basis of fluid channels with pillar structures, for instance micro-fabricated pillar structures. Chemical reactor systems encompass among others liquid chromatography systems, although the invention is not limited to this.

It was surprisingly found that the embodiments in accordance with the present invention provide chemical reactor devices based on liquid plug flows, whereby the edge effects are reduced or are even negligible without this in itself being a limitation on the pillar distance in the fluid channel at positions away from the edge.

It is an advantage of at least some of the embodiments in accordance with the present invention that in addition to a solution for the edge problem, the provided chemical reactor devices also have a very good separation ability.

It is an advantage of at least some of the embodiments in accordance with the present invention that in addition to a solution for the edge problem, the provided chemical reactor devices can also generate a uniform retention time for various parts of a fluid flow.

It is an advantage of at least some embodiments in accordance with the present invention that in addition to a solution for the edge problem, the provided chemical reactor devices also imply a limited column length because of the advantageous width—length aspect ratio of the pillar structures, allowing compact devices to be obtained.

It is an advantage of at least some of the embodiments in accordance with the present invention that the edge effects can both be reduced or be negligible for components that interact with the structures and walls in the reactor as well as for components that do not interact with the structures and walls in the reactor.

It is an advantage of at least some of the embodiments in accordance with the present invention that devices are obtained in which unwanted dispersion can be reduced and in some cases can even be made negligible.

The above objective is achieved by an apparatus and a method in accordance with the embodiments in accordance with the present invention.

The present invention relates to a chemical reactor device based on a fluid flow, the chemical reactor apparatus comprising a substrate with a fluid channel defined by a channel wall, whereby the channel has an inlet and an outlet and whereby the channel has a longitudinal axis, in accordance with the average direction of a fluid flow in the channel from inlet to outlet, an ordered set of pillar structures positioned in the channel, whereby the individual pillar structures have a length in the direction of the longitudinal axis of the channel and a width in a direction perpendicular to the longitudinal axis, and in which the individual pillar structures have a width to length ratio of at least 7.

The individual pillar structures can have a width to length ratio (aspect ratio) of at least 10.

The smallest distance (W) between the channel wall and a wall of a neighboring, non-touching, pillar structure can be greater than 0.9 times, greater than, for example, the smallest distance (B) between two neighboring pillar structures themselves.

It is an advantage of the present invention that by making use of pillar structures with a large width to length ratio, the edge effects in a fluid channel be reduced and possibly even are negligible.

The smallest distance (W) between the channel wall and a wall of an adjoining, non-touching pillar structure, and the smallest distance (B) between two adjoining pillar structures themselves, may be measured in the width direction of the channel, perpendicular on the longitudinal axis.

The wall can at least for some portion be flat, also called straight, in the longitudinal direction of the channel.

The pillar structures can be positioned in such a way that they determine a set of bound longitudinal and transversal micro-channels, whereby a first subset of longitudinal micro-channels is extending in the direction of the longitudinal axis and is defined through the wall of two pillar structures and a second subset of longitudinal micro-channels is extending in the direction of longitudinal axis and defined through the channel wall and a wall of a pillar structure, and wherein the smallest width (B) of the first subset can be smaller than or equal to the smallest width (W) of the second subset.

It is an advantage of the embodiments in accordance with the present invention that a low interpillar distance can be achieved, resulting in a high pressure in the system, while the edge effects can be limited, negligible or absent.

The pillar structures can be micro-fabricated pillar structures.

The pillar structures can have a width to length ratio of more than 12.

The smallest distance (B) between two neighbouring pillar structures can be between 0.5 and 0.8 times the smallest distance (W) between the channel wall and a wall of a neighbouring, non-touching, pillar structure.

The individual pillar structures can have a polygonal cross-section.

The individual pillar structures can have a substantial hexagonal cross-section.

The individual pillar structures may be limited in width by side walls of the pillar structures situated along the longitudinal axis of the channel and the length of the side walls may be at least 0.02, preferably 0.1 times the length of the pillar structures.

The channel and the micro-channels formed by the pillar structures may furthermore be limited on two sides by substrates.

The chemical reactor can be a liquid chromatography separation apparatus.

The channel wall can be formed by a membrane.

The present invention also relates to a mask for the lithographic application of a structure in a substrate for the making of a chemical reactor device, the mask comprising design elements for defining of an ordered set of pillar structures positioned in a channel of the chemical reactor device, whereby the individual pillar structures have a length in the direction of the longitudinal axis of the channel and a width in a direction perpendicular on the longitudinal axis, whereby the design elements are provided in the mask such that the resulting individual pillar structures have a width to length proportion of at least 7.

The design elements can be so defined such that the resulting pillar structures are positioned in the channel so that the smallest distance (W) between the channel wall defining the channel and a wall of a neighbouring, non-touching, pillar structure is greater than 0.9 times, for instance larger than, the smallest distance (B) between two neighbouring pillar structures themselves. The smallest distance (W) between the channel wall which defines the channel and a wall of a neighboring, non-touching, pillar structure can be greater than or equal to the smallest distance (B) between two neighboring pillar structures themselves. The smallest distance (W) between the channel wall which defines the channel and a wall of a neighboring, non-touching, pillar structure can be greater than the smallest distance (B) between two neighboring pillar structures themselves.

The design elements can be adapted so that the resulting pillar structures are bounded in width by pillar structure side walls situated according to the longitudinal axis of the channel and, wherein the length of the side walls is at least 0.02 times, preferably 0.1 times, even more by preference 0.2 times, of the length of the pillar structures.

The mask may be such that the formed wall of the channel be at least flat for some portion, also called the right section, in the longitudinal direction of the channel. The present invention also relates to a method for the manufacture of a chemical reactor system, the method comprising lithographically implementing a channel with pillar structures including using a mask as described above.

Specific and preferential aspects of the invention are included in the attached independent and dependent claims. Characteristics of the dependent claims can be combined with characteristics of the independent claims and with the characteristics of other dependent claims as appropriate and not only as expressly stated in the claims to be brought forth.

### BRIEF DESCRIPTION OF THE DRAWINGS

FIG. 1 illustrates a schematic representation of a part of a conventional chromatography column, whereby a solution for the edge problem is applied as provided for in the state of the art technology.

FIG. 2 illustrates a schematic representation of the dimensions of channels at the wall and away from the wall in the channel, as defined in an embodiment of the present invention.

FIG. 3 illustrates a schematic representation of a pillar structure as can be used in an embodiment in accordance with the present invention.

FIG. 4 illustrates the dispersion behavior for on-target features and off-target features, by which the advantage of the embodiments in accordance with the present invention is illustrated.

FIG. 5 shows the flow behavior in columns with on-target features (left) and off-target features (right) for pillar structures with smaller (above) and greater width to length aspect ratio, which illustrates the advantage of the embodiments in accordance with the present invention.

FIG. 6 illustrates the flow behavior in a channel with pillar structures with a high width to length aspect ratio, which indicates the advantage of the embodiments in accordance with the present invention.

FIG. 7 illustrates a schematic example of a pillar structure as defined on a mask and as implemented on a substrate corresponding to an embodiment of an aspect in accordance with the present invention.

FIG. 8 shows a schematic overview of a part of a chemical reactor with an input, an output and a pillar structure corresponding to an embodiment of an aspect in accordance with the current invention.

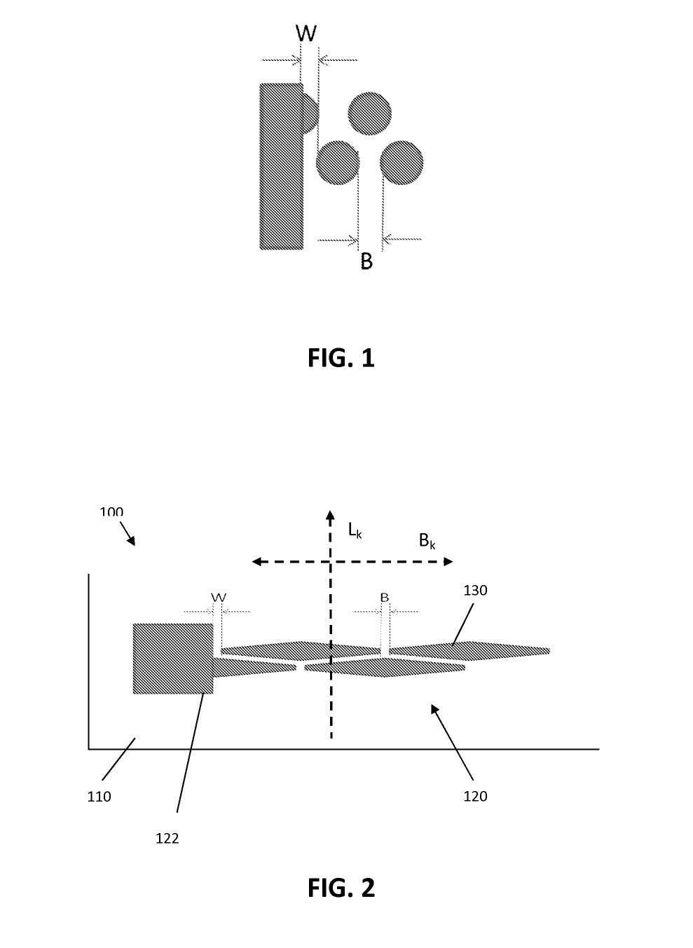

The figures are only schematic and not limiting. In the figures, the dimensions of some parts may be exaggerated and may not be to scale and are proposed for illustrative purposes. The dimensions and relative dimensions do not necessarily correspond to those of practical embodiments of the invention. Reference numbers in the claims should not be interpreted to limit the scope of the protection.

### DETAILED DESCRIPTION OF ILLUSTRATIVE EMBODIMENTS OF THE INVENTION

The present invention will be described referring to specific embodiments and to certain drawings but the invention is not limited thereto and is only limited by the claims.

It should be noted that the term “contains” and “comprises”, as used in the claims, should not be interpreted as restricted to the means listed thereafter; this term does not exclude other elements or steps. It is thus to be interpreted as specifying the presence of the stated features, values, steps or components as referred to, but this does not preclude the presence or addition of one or more other features, values, steps or components, or groups thereof. Thus, the scope of the expression “a device comprising components A and B” should not be limited to devices existing only of components A and B. It means that with regard to the present invention, A and B are the only relevant components of the device.

Reference throughout this specification to “one embodiment” or “an embodiment” means that a particular feature, structure or characteristic described in connection with the embodiment is included in at least one embodiment of the present invention. Therefore, appearances of the expressions “in one embodiment” or “in an embodiment” at various locations throughout this specification do not all necessarily refer to the same embodiment, but may do so. Furthermore, the particular features, structures or characteristics may be combined in any suitable manner, as would be apparent to one skilled in the art on the basis of this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than explicitly recited in each claim. Rather, as the following claims reflect, inventive aspects lie in less than all features of one single foregoing disclosed embodiment. Therefore, the claims following the detailed description are hereby explicitly incorporated into this detailed description, with each claim standing on its own as a separate embodiment of this invention.

Furthermore, while some embodiments of the invention described herein include some but not other features included in other embodiments, combinations of features of different embodiments are meant to be within the scope of the invention, and form different embodiments, as would be understood by one skilled in the art. For example, in the following claims, any of the claimed embodiments can be used in any combination.

It should be noted that the use of certain terminology in describing certain features or aspects of the invention should not be understood to imply that the terminology herein is being redefined to be limited to particular characteristics of the features or aspects of the invention to which this terminology is linked.

Where in the present description and claims reference is made to micro-channels, reference is made to channels wherein at least one of the dimensions lies in the range of 50 μm to 1 μm.

Where in the present description and claims reference is made to an ordered set, reference is made to a set of elements which are not randomly positioned, but where a specific relationship exists between the distances of the elements to each other.

Where in the present description and claims reference is made to distribution or dispersion, reference is made to the spatial spread over an area or volume.

Where in the present description and claims reference is made to the permeability, reference is made to the flow rate at which a liquid can flow through the liquid channel with pillar structures.

In a first aspect the present invention relates to a chemical reactor device based on a fluid flow. Such a chemical reactor device is typically suitable for the propagation of a fluid plug, for example a liquid plug. The chemical reactor device according to embodiments of the present invention may be a liquid chromatography device, although embodiments are not restricted thereto. Another specific example is a gas chromatography device. The chemical reactor can more generally be suitable for producing certain components, such as intermediaries, for the synthesis of components such as synthesis of nanoparticles, for the separation and/or extraction of components, etc.

According to embodiments of the present invention the chemical reactor device comprises a substrate with a fluid channel. The substrate can be any suitable substrate, such as for example a polymer substrate, semiconductor substrate, a metal substrate, a ceramic substrate, or a glass or vitreous substrate. The substrate can, for example, be a typical microfluidic substrate. The fluid channel can be a channel that is formed in the substrate or can be a channel that is formed on the substrate. In a specific embodiment, the invention not being limited hereto, the fluid channel is provided as a recess in the substrate and a second substrate is provided on top of the first substrate so as to obtain a fluid channel that is closed at the top, side and bottom. Such a second substrate can be a membrane. In such an embodiment the channel is typically rectangular in cross-section. According to embodiments of the present invention the fluid channel also has an inlet and an outlet for the supply and the removal of the fluid, for example, the liquid. In the specific embodiment described above such an inlet and outlet can be provided by means of perforations in the first and/or the second substrate.

The fluid channel can have a length depending on the application. By the use of particular inlet structures and/or outlet structures, for example distributors, the necessary length can moreover be influenced. A typical width of the fluid channel can be chosen as necessary. The necessary width will typically depend on the selected length and vice versa. In one set of examples the width of the fluid channel Bₖ may be selected in the range of 0.1 mm to 250 mm.

For the fluid channel a longitudinal axis can typically be defined, whereby the longitudinal axis is situated according to the direction of the average flow direction of the fluid in the channel, from inlet to outlet. By way of illustration the longitudinal axis in the schematic example of the chemical reactor 100 is shown in FIG. 2. In addition, also the substrate 110, the channel 120 itself and the channel wall 122 are indicated in FIG. 2. The channel wall 122 defines the fluid channel 120. It should be noted that the channel wall 122 can be defined by substrate material, but alternatively a membrane can also be used for defining the channel wall. The channel wall can, at least over a portion, be flat, also called straight, in the longitudinal direction of the channel. On some other parts of the channel wall, a partial pillar structure may be formed.

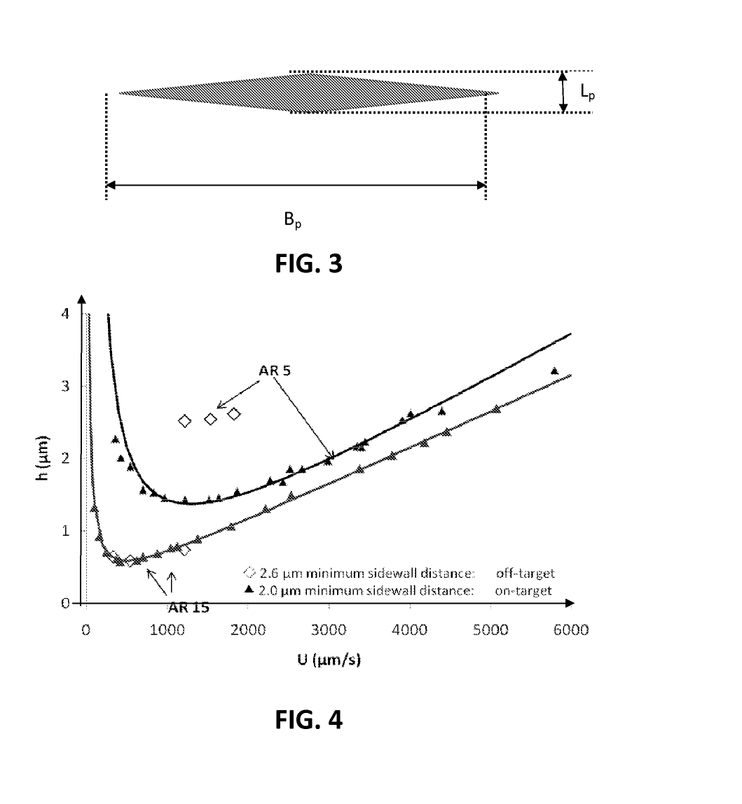

According to embodiment of the present invention an ordered set of pillar structures 130 is also provided in the fluid channel 120. These pillar structures can be micro-fabricated pillar structures, although embodiments are not limited thereto. The pillar structures may be based on precision manufacturing techniques. According to embodiments of the present invention, the pillar structures 130 have an elongated shape. The specific geometric elongated shape of the pillar structures can be any appropriate shape. A cross-section of the pillar structure may for example be diamond-shaped, elliptical, oval, polygonal, etc. As an illustration, a magnified image of an exemplary pillar structure 130 is shown in FIG. 3, where the cross-section is diamond-shaped. In FIG. 3 the length Lₚ of the pillar structure 130 is indicated, as well as the width Bₚ of the pillar structure 130. Herein, the length of the pillar structure is the maximum dimension of the pillar structure in the direction Lₖ of the longitudinal axis of the channel in which the pillar structures are positioned, and the width of the pillar structure is the maximum dimension of the pillar structure in the direction perpendicular to the longitudinal axis of the channel, that is the direction that also defines the width direction Bₖ of the channel itself. The elongated shape of the pillar structure is according to embodiments of the present invention such that the pillar structures have a width-to-length ratio of at least 7, preferably more than 10 or more than 12. It was surprisingly found that for pillar structures having a large width-to-length aspect ratio, edge effects do not have a significant influence on the flow profile.

The number of pillars provided in the channel can be chosen depending on the objective (for example the separation capability) that is to be obtained. The number of pillars which can be provided on a particular row in the fluid channel is dependent on the width of the channel. There may, for example, be provided between 3000 and 3 pillars per mm width of the channel. The absolute width of the pillars may have been chosen in a range between 0.3 μm and 50000 μm. The absolute distance between the pillars in the channel remote from the wall can for example be chosen in a range between 0.05 μm and 2000 μm. In preferred embodiments of the present invention, the interpillar distance may be chosen from the range between 0.1 μm and 1000 μm, preferably between 0.3 μm and 3 μm. In addition, the size and shape of the pillars may vary, for example along the longitudinal axis of the channel.

In some specific embodiments of the present invention the pillar structures are positioned in the channel in such a way that the smallest distance (W) between the channel wall and a wall of a neighboring but not-touching, pillar structure is larger than 0.9 times, for example larger than, the smallest distance (B) between two neighboring pillar structures. It was surprisingly found that, although the width of the micro channels formed by the wall and the pillar structures is larger than the width of the micro channels formed by pillars remote from the channel wall, this actually does not cause edge effects when pillars are used as defined above. This surprising conclusion results from the fact that—apart from technological restrictions for the manufacture of the structures—the interpillar distance is no longer defined by the dimensions of the channels against the wall. This allows the interpillar distance to be chosen smaller than expected, which allows very efficient fluid channels to be made, for example, columns. It should be noted in this respect that this implementation can occur without loss of resolution or without introduction of additional dispersion.

In a specific embodiment of the present invention the chemical reactor is a liquid chromatography apparatus and the fluid channel is a separation column. It is an advantage that the separation efficiency of the system can be high due to the large lateral migration that occurs, while furthermore no edge effects occur or that these are negligible. In addition, because of the specific width-to-length ratio of the pillars, the necessary length of the column to obtain a certain degree of separation can be reduced.

It is an advantage of some embodiments of the present invention that they are based on sets of organized pillar structures, through which a low dispersion can be obtained. When the band dispersion is described by means of the Van Deemter equation, i.e.

H=A+B/u+C·u

whereby A, B, C are constants and u is the linear velocity of the mobile phase, structures according to the present invention also result in an exceptional low A value (representative for the dispersion due to flow differences in the paths) and a low B value (representative for the dispersion due to the longitudinal diffusion).

One or more additional components may also be present in the chemical reactor according to embodiments of the present invention, depending on the functionality of the chemical reactor, as known by one skilled in the art. In some embodiments of the present invention for example one or more distributors may be present, a detector may be present, which may be integrated or not in one of the substrates of the chemical reactor, a further micro-fluidized network may be present, electrodes may be present (for example in a chemical reactor based on electrophoresis or an electrochemical reactor), a membrane or a filter, a catalytic bed, a heat exchanger, a radiation source, etc.

In a specific embodiment of the present invention the pillar structures can also have a form as further described in a further aspect of the present invention.

By way of illustration FIG. 8 shows a schematic overview of a part of a chemical reactor having an input, an output and a pillar structure in accordance with an embodiment of an aspect of the present invention.

In another aspect, the present invention also relates to a mask with a design for forming the pillar structures as described above. The mask can comprise typical design elements for defining an ordered set of pillar structures positioned in a fluid channel of a chemical reactor, whereby the pillar structures have a length in the direction of the longitudinal axis of the channel and a width in a direction perpendicular to the longitudinal axis, and whereby the design elements are provided in the mask in such a way that the resulting pillar structures have a width-to-length ratio of at least 7. In some embodiments of the present invention the design elements of the mask are optionally further provided such that the pillar structures produced in the channel on the basis of the mask have a smallest distance (W) between the channel wall and a wall of a neighboring, non-touching, pillar structure which is larger than 0.9 times, for example larger than, the smallest distance (B) between two neighboring pillar structures among themselves. The mask may furthermore comprise additional design features characteristic for a channel wall for defining a fluid channel in a substrate. Further designs elements from the mask may also be provided in such a manner that characteristics of the pillar structures and their relation to the channel as described in the first aspect, are obtained. Moreover the mask may also be adapted with design features to define characteristics of pillar structures for the chemical reactor as further described in the further aspect.

The present invention also relates to a method for manufacturing a chemical reactor, such as for example a chromatography device with a chromatography column, where the method comprises the use of a mask as defined above. The method may comprise the step of lithographic printing of a mask on a substrate to generate substrate features, and the etching of the substrate features to generate pillar structures. Other characteristics of the manufacturing process of the chemical reactor can be as known by one skilled in the art and are therefore not described in further detail here.

By way of illustration, embodiments of the present invention not being limited thereby, a comparative study is discussed below wherein the flow behavior and the occurrence or not of edge effects is studied in function of the use of pillar structures with a large width-to-length ratio.

Columns with a length of 1 cm and a width of 1 mm were produced, whereby pillar structures with a different width-to-length aspect ratio were used for different columns, in order to evaluate the effect of this aspect ratio. The interpillar distance as well as the length of the pillars (in the direction of the longitudinal axis of the column) was kept constant, in the present example 2.5 μm and 5 μm respectively, while the width of the pillar structures varied per column, from 10 μm (resulting in an aspect ratio of 2) to 125 μm (resulting in an aspect ratio of 25). The pillar structures, the inlet and the outlet were manufactured with the use of mid-UV photo-lithography on a (100) silicon wafer substrate. After the photo-lithographic process, the pillar structures were etched on the basis of a Bosch etching process, so that a depth of 8 micrometers was obtained. The photoresist was then removed, using an oxygen plasma etching and nitric acid. The inlet and outlet were further defined by a 800 μm etching using a Bosch etching process via the back side of the substrate. The reactor was closed by making use of a Pyrex substrate which was anodically bonded to the silicon substrate.

For measurement of the results the following experimental setup was used. An automatic valve system was used to inject the sample into the structure. For obtaining the propagation of the liquid phase a nitrogen pressure supply was used. During the injection step the inlet and the outlet of the circuit in which the mobile phase moves was closed, while during the subsequent sample preparation, the inlet and the outlet of the sample injection circuit was redirected to a capillary tube with high flow resistance so that a small leakage flow was created so as to avoid tail formation. In order to follow the flow behavior use was made of fluorescent dyes which were excited during registration by means of a mercury-vapor UV source. Visualization of the fluorescence was performed using an air-cooled CCD camera.

It was possible to determine that for pillar structures with an aspect ratio varying from 2 to 25, the plate height could be reduced from 2.6 μm to 0.5 μm, because a reduction in longitudinal dispersion could be obtained. When the Van Deemter equation was considered, a reduction of the B term (representative for the longitudinal dispersion) with a factor of 15 could be established for the use of an aspect ratio of 25 in relation to an aspect ratio of 2. A good separation behavior could therefore be established.

In addition to this result it could also be determined that edge effects which occur in systems with pillars having a small aspect ratio, were greatly reduced or even negligible in the structures according to the present invention. This could be established on the basis of the CCD images recorded on the chemical reactor on the chip.

FIG. 4 illustrates the effect of the width-to-length aspect ratio of the pillar structures on edge effects. The graph in FIG. 4 shows the difference in dispersion behavior (minimal plate height h as a function of the speed) for on-target structures, i.e. a column whereby the distance between the wall and a neighboring pillar is 2 micrometer, and off-target structures, whereby the distance between the wall and a neighboring pillar is 2.6 micrometer (thus greater than the interpillar distance). It can be clearly seen that for pillar structures with a width-to-length aspect ratio of 5 a variation in the distance to the wall has a large influence on the dispersion behavior, while for pillar structures having a width-to-length aspect ratio of 15, this variation in distance to the wall has no substantial influence. This illustrates that in reactors in which pillars with a high width-to-length aspect ratio are used, the edge effects can be reduced or even neglected.

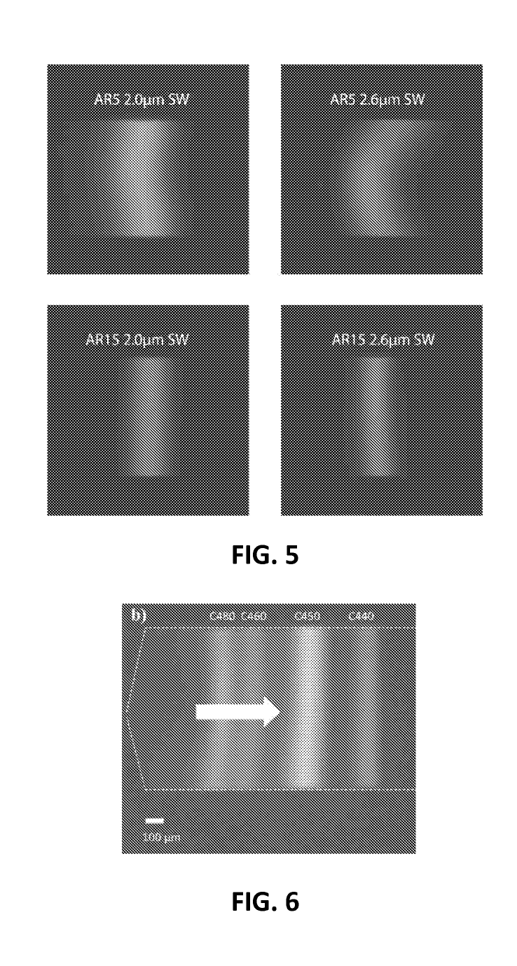

The same is illustrated in FIG. 5 in which the flow behavior of a liquid for the structures as described above is shown, by making use of fluorescence images for a liquid with a fluorescence marker. The images on the left show the on-target situation (i.e. with a 2 μm distance to the wall), which show relatively undisturbed flow profiles both for pillars with an aspect ratio of 5 and 15. The images on the right show the off-target situation (i.e. with a 2.6 μm distance to the wall, i.e. a distance greater than the interpillar distance), whereby a relatively undisturbed flow profile is obtained for pillars with an aspect ratio of 15, while for pillars with an aspect ratio of 5 the influence of edge effects on the flow profile is clearly visible.

Further by way of illustration a test is also reported here in which 4 fluorescent marker dyes (c440, c450, c460 and c480 in a 70/30 proportion of water/methanol) are separated in the first millimeter of a separation column wherein pillar structures having a width-to-length aspect ratio of 25 are provided. The column was functionalized with C8. The detection of the four bands as straight bands clearly indicates the absence of substantially contributing edge effects. An image of this detection is shown in FIG. 6. Through the efficient operation and the reduction of edge effects, for example a reduction of the column length can be obtained.

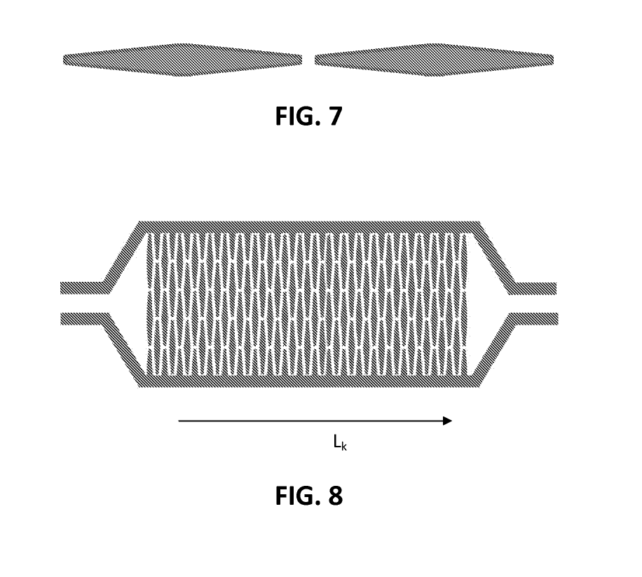

In a further specific aspect of the present invention, embodiments of a chemical reactor device are provided, based on a fluid flow, wherein the chemical reactor device also comprises a substrate with a fluid channel. This channel is also defined by a channel wall and also has an inlet and an outlet. For the channel also a longitudinal axis can be defined in accordance with the average flow direction of the fluid when it moves in the channel from the inlet to the outlet. The chemical reactor thereby also comprises an ordered set of pillar structures positioned in the channel, whereby the pillar structures have a length in the direction of the longitudinal axis of the channel and a width in a direction perpendicular to the longitudinal axis, and wherein the pillar structures have a width-to-length ratio of at least 7. According to embodiments of this aspect, the pillar structures are furthermore bounded in the width direction by side walls situated in accordance with the longitudinal axis of the channel, whereby the length of these side walls is at least 0.02 times, preferably at least 0.1 times, preferably at least 0.2 times, the length of the pillar structures. In other words, the sides of the pillar structures do not end in a tip, but end in a wall parallel with the wall of the channel. By way of example, the pillar structure may have in such a case a hexagonal cross-section. An illustration of such an exemplary pillar structure is shown in FIG. 7. Further characteristics of the chemical reactor may be as described in the first aspect, although the invention is not limited thereto. An advantage of these pillar structures is that they can be produced with a good degree of reproducibility, so that reliable structures are obtained. This is a contrast with pillar structures that end in a tip and whereby, mainly in the case of large width-to-length aspect ratios of the pillar structures, obtaining properly formed pillar structures is less reliable and reproducible. An additional advantage of the use of pillar structures as described in embodiments of the present aspect is that the interpillar distance can also be obtained in a uniform and reproducible manner for the set of pillar structures. The effect of this is that a better dispersion behavior (less dispersion) is obtained for the flow of the fluid that flows through the channel.

The present invention also relates to a mask with a design for forming the pillar structures as described above. The mask can typically comprise design elements for defining an ordered set of pillar structures positioned in a fluid channel of a chemical reactor, whereby the pillar structures have a length in the direction of the longitudinal axis of the channel and a width in a direction perpendicular to the longitudinal axis, and whereby the design elements are provided in the mask in such a way that the resulting pillar structures have a width-to-length ratio of at least 7 and the pillar structures moreover are bounded in the width direction by side walls situated according to the longitudinal axis of the channel, whereby the length of the side walls is at least 0.02 times, preferably at least 0.1 times, preferably at least 0.2 times, the length of the pillar structures. Further designs elements of the mask may also be provided in such a manner that characteristics of the pillar structures as described in the first aspect are obtained.

The present invention also relates to a method of manufacturing a chemical reactor, such as for example a chromatography device with a chromatography column, whereby the method comprises the use of a mask as defined above. The method may comprise the step of lithographic printing of a mask on a substrate to generate substrate features, and the etching of the substrate features to generate pillar structures. Other characteristics of the manufacturing process of the chemical reactor can be as known to the skilled person, and are therefore not described in further detail here.

1-21. (canceled)

22. A chemical reactor device based on a fluid flow, the chemical reactor device comprising
a substrate with a fluid channel defined by a channel wall, whereby the channel has an inlet and an outlet and whereby the channel has a longitudinal axis in accordance with the average fluid flow direction of a liquid in the channel from inlet to outlet,
an ordered set of pillar structures positioned in the channel, whereby the individual pillar structures have a length in the direction of the longitudinal axis of the channel and a width in a direction perpendicular to the longitudinal axis,
wherein the individual pillar structures have a width-to-length ratio of at least 7.

23. A chemical reactor device according to claim 22, where the individual pillar structures have a width-to-length ratio of at least 10.

24. A chemical reactor device according to claim 22, wherein the smallest distance (W) between the channel wall and a wall of a neighboring, non-touching, pillar structure is greater than 0.9 times the smallest distance (B) between two neighboring pillar structures.

25. A chemical reactor device according to claim 22, wherein the smallest distance (W) between the channel wall and a wall of a neighboring, non-touching, pillar structure is greater than the smallest distance (B) between two neighboring pillar structures.

26. A chemical reactor device according to claim 24, wherein the smallest distance (W) between the channel wall and a wall of a neighboring, non-touching pillar structure, and the smallest distance (B) between two neighboring pillar structures, are measured in the width direction of the channel, perpendicular on the longitudinal axis.

27. A chemical reactor device according to claim 22, wherein the pillar structures are positioned such that they determine a set of linked longitudinal and transversal micro-channels, wherein a first subset of longitudinal micro-channels extends in the direction of the longitudinal axis and is defined by the wall of two pillar structures and a second subset of the longitudinal micro-channels extends in the direction of the longitudinal axis and is defined by the channel wall and a wall of a pillar structure, and wherein the smallest width (B) of the first subset is smaller than or equal to the smallest width (W) of the second subset.

28. A chemical reactor device according to claim 22, wherein the pillar structures are micro-fabricated pillar structures.

29. A chemical reactor device according to claim 22, wherein the pillar structures have a width-to-length ratio of at least 12.

30. A chemical reactor device according to claim 22, wherein the smallest distance (B) between two neighboring pillar structures is between 0.5 times and 0.8 times (W) the smallest distance (W) between the channel wall and a wall of a neighboring, non-touching, pillar structure.

31. A chemical reactor device according to claim 22, wherein the individual pillar structures have a polygonal cross-section.

32. A chemical reactor device according to claim 31, wherein the individual pillar structures have a hexagonal cross-section.

33. A chemical reactor device according to claim 31, wherein the individual pillar structures are bounded in the width direction by sidewalls situated in accordance with the longitudinal axis of the channel and wherein the length of the sidewalls are at least 0.02 times the length of the pillar structures.

34. A chemical reactor device according to claim 22, wherein the channel and the micro-channels formed by the pillar structures are furthermore limited on two sides by substrates.

35. A chemical reactor device according to claim 22, wherein the chemical reactor is a liquid chromatography separation device.

36. A chemical reactor device according to claim 22, wherein the channel wall is formed by a membrane.

37. A chemical reactor device according to claim 22, wherein the channel wall is at least over a portion flat in the longitudinal direction of the channel.

38. A mask for the lithographic application of a structure in a substrate for the manufacture of a chemical reactor device, the mask comprising
design elements for defining an ordered set of pillar structures positioned in a channel of the chemical reactor device, whereby the individual pillar structures have a length in the direction of the longitudinal axis of the channel and have a width in a direction perpendicular on the longitudinal axis, whereby the design elements are provided in the mask in such a way that the resulting individual pillar structures have a width-to-length ratio of at least 7.

39. A mask according to claim 38, wherein the design elements are defined such that the resulting pillar structures are positioned in the channel in such a way that the smallest distance (W) between the channel wall defining the channel and a wall of an adjoining, non-touching, pillar structure is greater than 0.9 times the smallest distance (B) between two neighboring pillar structures or wherein the design elements are adjusted so that the resulting pillar structures are bounded in the width direction by sidewalls situated according to the longitudinal axis of the channel and wherein the length of the sidewalls is at least 0.02 times the length is of the pillar structures.

40. A mask according to claim 39, wherein the design elements are defined such that the resulting pillar structures are positioned in such a way in the channel that the smallest distance (W) between the channel wall defining the channel and a wall of a neighboring, non-touching, pillar structure is greater than the smallest distance (B) between two neighboring pillar structures.

41. A method of manufacturing a chemical reactor device, wherein the method comprises the lithographic implementation of a channel with pillar structures using a mask according to claim 38.
